(19) United States
(12) Patent Application Publication
(10) Pub. No.: US 2025/0167397 A1
(43) Pub. Date: May 22, 2025

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Min Jeong LEE, Suwon-si (KR); Chang Hong KO, Suwon-si (KR); Sam Jin PARK, Suwon-si (KR); Soo Hee KIM, Suwon-si (KR); Jin Weon SEO, Suwon-si (KR); Yoo Bin HAN, Suwon-si (KR); Eon Mi LEE, Suwon-si (KR)

(73) Assignee: SAMSUNG SDI CO., LTD., Yongin-si (KR)

(21) Appl. No.: 18/956,592

(22) Filed: Nov. 22, 2024

(30) Foreign Application Priority Data
Nov. 22, 2023 (KR) 10-2023-0163394

(51) Int. Cl. H01M 50/446; H01M 10/0525; H01M 50/42; H01M 50/434; H01M 50/449; H01M 50/489

(52) U.S. Cl. CPC H01M 50/446; H01M 10/0525; H01M 50/42; H01M 50/434; H01M 50/449; H01M 50/489

(57) ABSTRACT

The present disclosure relates to a separator for a rechargeable lithium battery, and a rechargeable lithium battery including the separator. The separator includes a porous substrate, and a coating layer located on at least one surface of the porous substrate. The coating layer includes a cross-linked product of a binder and a cross-linking agent, a filler, and an adhesive binder that includes a (meth)acryl-based binder containing a first structural unit and a second structural unit, the cross-linking agent includes an aziridine-based cross-linking agent, the filler has a particle diameter D100 of 1.0 μm or less, and the adhesive binder includes a first structural unit derived from a vinyl aromatic-based monomer, a second structural unit derived from an alkyl (meth)acrylate, and a third structural unit derived from a phosphonate-based monomer.

### CROSS-REFERENCE TO RELATED APPLICATION

The present application claims the benefit of priority to Korean Patent Application No. 10-2023-0163394, filed on Nov. 22, 2023 in the Korean Intellectual Property Office, the entire disclosure of which is incorporated herein by reference.

### BACKGROUND

### 1. Field of the Disclosure

Examples of the present disclosure relate to a separator for a rechargeable lithium battery, and a rechargeable lithium battery including the separator.

### 2. Discussion of Related Art

With increasing use of electronic devices, such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery is typically a battery including a positive electrode and a negative electrode that contain an active material capable of the intercalation and deintercalation of lithium ions, and that produces electric energy by oxidation and reduction reactions when the lithium ions are intercalated into and deintercalated from the positive electrode and the negative electrode.

The rechargeable lithium battery may include a separator between the positive electrode and the negative electrode. The separator is impregnated in an electrolyte. It may be advantageous for the separator to maintain an original form thereof without undergoing thermal shrinkage in the electrolyte to secure the safety of the battery.

### SUMMARY OF THE DISCLOSURE

An example embodiment includes a separator for a rechargeable lithium battery, the separator having an improved dry shrinkage ratio and shrinkage ratio in an electrolyte, thereby increasing the safety of the battery.

Another example embodiment includes a separator for a rechargeable lithium battery, which has increased wet bonding strength and improved high-temperature lifetime characteristics

Still another example embodiment is directed to providing a rechargeable lithium battery including the separator for a rechargeable lithium battery.

According to an aspect of the present disclosure, a separator for a rechargeable lithium battery includes a porous substrate, and a coating layer located on at least one surface of the porous substrate. The coating layer includes a cross-linked product of a binder and a cross-linking agent, a filler, and an adhesive binder, the binder includes a (meth)acryl-based binder containing a first structural unit derived from (meth)acrylamide, and a second structural unit including at least one of a structural unit derived from (meth)acrylic acid, (meth)acrylate, or a salt thereof and a structural unit derived from (meth)acrylamido sulfonic acid or a salt thereof, the cross-linking agent includes an aziridine-based cross-linking agent. The filler has a particle diameter D100 of about 1.0 μm or less, and the adhesive binder includes a first structural unit derived from a vinyl aromatic-based monomer, a second structural unit derived from an alkyl (meth)acrylate, and a third structural unit derived from a phosphonate-based monomer.

According to another aspect of the present disclosure, a rechargeable lithium battery includes the separator for a rechargeable lithium battery, a positive electrode, and a negative electrode.

### BRIEF DESCRIPTION OF THE DRAWINGS

FIG. 1 is a cross-sectional view illustrating a separator for a rechargeable lithium battery, according to an example embodiment.

FIGS. 2-5 are cross-sectional views schematically illustrating a rechargeable lithium battery according to an example embodiment.

### DETAILED DESCRIPTION

Hereinafter, example embodiments of the present disclosure is described in detail. However, the example embodiments are presented as examples, and the present disclosure is not limited to the example embodiments, and the present disclosure is only defined by the scope of the appended claims.

Unless otherwise stated herein, when a part such as a layer, a membrane, an area, a plate, etc. is described as being disposed “on” another part, it includes not only a case where the part is “directly above” another part, but also a case where there are other parts therebetween.

Unless otherwise stated herein, the singular expression may also include the plural. In addition, unless otherwise stated, “A or B” may mean “including A, including B, or including A and B.”

In the present specification, “a combination thereof” may mean a mixture, stack, composite, copolymer, alloy, blend, and reaction product of constituents.

In the present specification, “particle diameter D100” refers to a particle diameter of a particle with a cumulative volume of 100% by volume in a particle size distribution. The particle size distribution may be measured by methods known to those skilled in the art. For example, the particle size distribution may be measured using a particle size analyzer or measured using a transmission electron micrograph or a scanning electron micrograph. As another method, the particle size distribution may be measured using a measuring device using dynamic light scattering, and a D100 value may be obtained by performing data analysis, counting the number of particles in each particle size range, and then calculating the D100 value therefrom. Alternatively, the particle size distribution may be measured using a laser diffraction method. When measuring the average particle diameter by a laser diffraction method, for example, D100 based on 100% of a particle diameter distribution in a measuring device may be calculated by dispersing particles to be measured in a dispersion medium, then introducing the particles into a commercially available laser diffraction particle diameter measuring device (e.g., Microtrac's MT 3000), and radiating ultrasonic waves of about 28 kHz at an output power of 60 W.

In the present specification, “particle diameter D50” refers to a particle diameter indicating a diameter of a particle whose cumulative volume is 50% by volume in the particle size distribution. The particle diameter distribution may be obtained by referring to the method described for the “particle diameter D100.”

In the present specification, the term “(meth)acryl” refers to acryl and/or methacryl.

Hereinafter, unless otherwise defined, “substitution” means that hydrogen in a compound is substituted with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxy group (—OH), a nitro group (—NO₂), a cyano group (—CN), an amino group (—NRR′) (here, R and R′ are each independently hydrogen or a C1 to C6 alkyl group), a sulfobetaine group (—RR′N⁺(CH₂)ₙSO₃—, n is a natural number from 1 to 10), a carboxybtaine group (—RR′N⁺(CH₂)ₙCOO—, n is a natural number from 1 to 10) (here, R and R′ are each independently a C1 to C20 alkyl group), an azido group (—N₃), an amidino group (—C(═NH)NH₂), a hydrazino group (—NHNH₂), a hydrazono group (═N(NH₂)), a carbamoyl group (—C(O)NH₂), a thiol group (—SH), an acyl group (—C(═O)R, here, R denotes hydrogen, a C1 to C6 alkyl group, a C1 to C6 alkoxy group, or a C6 to C12 aryl group), a carboxyl group (—COOH) or a salt thereof (—C(═O)OM, here, M denotes an organic or inorganic cation), a sulfonic acid group (—SO₃H) or a salt thereof (—SO₃M, here, M denotes an organic or inorganic cation), a phosphate group (—PO₃H₂) or a salt thereof (—PO₃MH or —PO₃M₂, here, M denotes an organic or inorganic cation), and a combination thereof.

Hereinafter, the C1 to C3 alkyl group may be or include at least one of a methyl group, an ethyl group, or a propyl group. The C1 to C10 alkylene group may be or include, for example, at least one of a C1 to C6 alkylene group, a C1 to C5 alkylene group, or a C1 to C3 alkylene group and may be or include, for example, at least one of a methylene group, an ethylene group, or a propylene group. The C3 to C20 cycloalkylene group may be or include, for example, at least one of a C3 to C10 cycloalkylene group, or a C5 to C10 alkylene group, for example, a cyclohexylene group. The C6 to C20 arylene group may be or include, for example, a C6 to C10 arylene group, for example, a phenylene group. The C3 to C20 heterocyclic group may be or include, for example, a C3 to C10 heterocyclic group, for example, a pyridine group.

Hereinafter, “hetero” means including one or more heteroatoms such as or including at least one of N, O, S, Si, and P.

In addition, in Chemical Formula, the symbol * refers to a part that is connected to the same or different atom, group, or structural unit.

Hereinafter, “alkali metal” refers to an element belonging to Group 1 of the periodic table, such as lithium, sodium, potassium, rubidium, cesium, or francium and may be present in a cationic or neutral state.

In the present specification, upon describing a numerical range, “X to Y” means “X or more and Y or less (X≤ and ≤Y).”

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

A separator for a rechargeable lithium battery according to an example embodiment includes a porous substrate and a coating layer located on at least one surface of the porous substrate. The coating layer includes a cross-linked product of a binder and a cross-linking agent, a filler, and an adhesive binder, the binder includes a (meth)acryl-based binder containing a first structural unit derived from (meth)acrylamide, and a second structural unit including at least one of a structural unit derived from (meth)acrylic acid, (meth)acrylate, or a salt thereof and a structural unit derived from (meth)acrylamido sulfonic acid or a salt thereof, the cross-linking agent includes an aziridine-based cross-linking agent. The filler has a particle diameter D100 of about 1.0 μm or less, and the adhesive binder includes a first structural unit derived from a vinyl aromatic-based monomer, a second structural unit derived from an alkyl (meth)acrylate, and a third structural unit derived from a phosphonate-based monomer.

The coating layer may include the cross-linked product of the (meth)acryl-based binder and the aziridine-based cross-linking agent, and the filler. Therefore, the separator for a rechargeable lithium battery may have a reduced dry shrinkage ratio and a shrinkage ratio in an electrolyte, thereby increasing thermal stability.

According to an example embodiment, the dry shrinkage ratio of the separator for a rechargeable lithium battery may be about 5% or less, and the shrinkage ratio in the electrolyte may be about 20% or less, for example, 15% or less, for example, 10% or less, or for example, 5% or less.

According to an example embodiment, the separator for a rechargeable lithium battery exhibits a significantly low shrinkage ratio in the electrolyte. The shrinkage ratio in the electrolyte is obtained in consideration of an application location of the separator in the rechargeable lithium battery. The separator may be saturated with the electrolyte. A separator with a low shrinkage ratio in an electrolyte can increase the stability of the battery by maintaining heat resistance properties without weakening the mechanical properties of the (meth)acryl-based binder when the separator is saturated with the electrolyte.

A separator formed of or including a composition containing the (meth)acryl-based binder but not containing the aziridine-based cross-linking agent as a cross-linking agent or containing a crosslinking agent other than the aziridine-based cross-linking agent may not satisfy the above shrinkage ratio range in the electrolyte.

According to an example embodiment, the aziridine-based cross-linking agent may be contained in an amount of about 95 wt % or more, for example, in the range of 98 to 100 wt %, or for example, 100 wt % of the total cross-linking agent in the composition.

A separator formed of or including a composition containing the (meth)acryl-based binder but that does not include a filler having a particle diameter D100 of about 1.0 μm or less, or that includes a filler having a particle diameter D100 of more than about 1.0 μm may not satisfy the above shrinkage ratio range in the electrolyte.

A separator formed of or including a composition containing the aziridine-based cross-linking agent and the filler but not containing the (meth)acryl-based binder, or containing a binder other than the (meth)acryl-based binder, may not satisfy the above dry shrinkage ratio and shrinkage ratio ranges in electrolyte. According to an example embodiment, the (meth)acryl-based binder may be contained in an amount of about 95 wt % or more, for example, in the range of 98 to 100 wt %, or for example, 100 wt % of the total binder in the composition.

According to an example embodiment, the (meth)acryl-based binder, the filler having a particle diameter D100 of about 1.0 μm or less, and the aziridine-based cross-linking agent are contained in the coating layer so that the separator including the coating layer containing the adhesive binder exhibits reduced dry shrinkage and shrinkage ratios in the electrolyte.

According to an example embodiment, the coating layer may include the cross-linked product of the composition containing the (meth)acryl-based binder, the aziridine-based cross-linking agent, and the filler having a particle diameter D100 of about 1.0 μm or less, and the adhesive binder. According to an example embodiment, the cross-linked product may be or include a heat cross-linked product.

According to an example embodiment, the coating layer may include the cross-linked product of the composition including the (meth)acryl-based binder, the aziridine-based cross-linking agent, the filler having a particle diameter D100 of about 1.0 μm or less, and the adhesive binder. According to an example embodiment, the cross-linked product may be or include a heat cross-linked product.

### Coating Layer

The coating layer may constitute a heat-resistant adhesive layer of the separator.

The coating layer may include a (meth)acryl-based binder including a first structural unit derived from (meth)acrylamide as a binder and a second structural unit including at least one of a structural unit derived from (meth)acrylic acid or (meth)acrylate and a structural unit derived from (meth)acrylamido sulfonic acid or a salt thereof.

According to an example embodiment, the total amount of the first structural unit and the second structural unit in the binder may be about 95 mol % or more, for example, in the range of 99 to 100 mol %, and 100 mol %. Within the above range, the above-described effects of the separator can be readily achieved.

The (meth)acryl-based binder is or includes a water-based heat-resistant binder, and may fix the filler on a porous substrate, provide bonding strength so that the coating layer is bonded to the porous substrate and an electrode, and may contribute to increasing the heat resistance, air permeability, and oxidation resistance of the separator.

The first structural unit derived from (meth)acrylamide has an amide functional group (—(C═O)—NH₂) in a structural unit. The —(C═O)—NH₂ functional group can increase the bonding characteristics with the porous substrate and the electrode, and more firmly fix inorganic particles in the coating layer by forming a hydrogen bond with the —OH functional group of the filler, thereby reinforcing the heat resistance of the separator.

The structural unit derived from (meth)acrylic acid, (meth)acrylate, or a salt thereof contained in the second structural unit may be configured to fix the filler on the porous substrate, and also provide bonding strength so that the coating layer is bonded to the porous substrate and the electrode, and may contribute to increasing the heat resistance and air permeability of the separator. In addition, the structural unit derived from (meth)acrylic acid, (meth)acrylate, or a salt thereof may contain a carboxyl functional group (—C(═O)O—) in the structural unit, thereby contributing to improving the dispersibility of a slurry for a coating layer.

The structural unit derived from the (meth)acrylamido sulfonic acid, or a salt thereof, contained in the second structural unit may contain a bulky functional group, thereby reducing the mobility of the binder containing the structural unit and reinforcing the heat resistance of the separator.

In an example embodiment, the (meth)acryl-based binder may be or include at least one of a binary copolymer containing a first structural unit derived from (meth)acrylamide and a second structural unit derived from (meth)acrylic acid, (meth)acrylate, or a salt thereof, a binary copolymer containing a first structural unit derived from (meth)acrylamide and a second structural unit derived from (meth)acrylamido sulfonic acid or a salt thereof, or a terpolymer containing a first structural unit derived from (meth)acrylamide, a second structural unit including a structural unit derived from (meth)acrylic acid, (meth)acrylate, or a salt thereof and a structural unit derived from (meth)acrylamido sulfonic acid or a salt thereof.

The first structural unit may be contained in an amount ranging from about 55 mol % to about 95 mol %, for example 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95 mol %, with respect to 100 mol % of the (meth)acryl-based binder, and the second structural unit may be contained in an amount ranging from about 5 mol % to about 45 mol %, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45 mol %, with respect to 100 mol % of the (meth)acryl-based binder. Within the above ranges, the (meth)acryl-based binder can be readily prepared, and the above-described effects of the coating layer can be readily provided.

In an example embodiment, the first structural unit may be contained in an amount ranging from about 75 mol % to about 95 mol %, for example, 80 mol % to 95 mol % or 80 mol % to 90 mol % with respect to 100 mol % of the (meth)acryl-based binder.

The structural unit derived from (meth)acrylic acid, (meth)acrylate, or a salt thereof of the second structural unit may be contained in an amount ranging from about 0 mol % to about 40 mol %, for example, from more than 0 mol % to about 40 mol % or less, from 1 to 40 mol %, or from 1 to 10 mol % with respect to 100 mol % of the (meth)acryl-based binder, and the structural unit derived from (meth)acrylamido sulfonic acid or a salt thereof may be contained in an amount ranging from about 0 mol % to about 10 mol %, for example, from more than 0 mol % to about 10 mol % or less, or from 1 to 10 mol %.

The structural unit derived from (meth)acrylamide may be contained in an amount ranging from about 80 mol % to about 90 mol % with respect to 100 mol % of the (meth)acryl-based binder, the structural unit derived from (meth)acrylic acid, (meth)acrylate, or a salt thereof may be contained in an amount ranging from about 0 mol % to about 40 mol %, for example, 1 to 10 mol % with respect to 100 mol % of the (meth)acryl-based binder, and the structural unit derived from (meth)acrylamido sulfonic acid or a salt thereof may be contained in an amount ranging from about 0 mol % to about 10 mol %, for example, 1 to 10 mol % with respect to 100 mol % of the (meth)acryl-based binder.

When the content of each structural unit is within the above range, the heat resistance and bonding strength of the separator can be further increased.

The first structural unit derived from (meth)acrylamide may be represented by Chemical Formula 1 below:

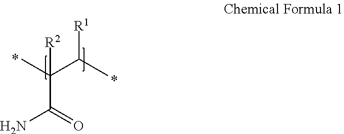

in Chemical Formula 1, R¹ and R² each independently are or include hydrogen or a methyl group.

The structural unit derived from (meth)acrylic acid or (meth)acrylate may be, for example, represented by any at least one of Chemical Formulas 2, 3, 4, and a combination thereof below:

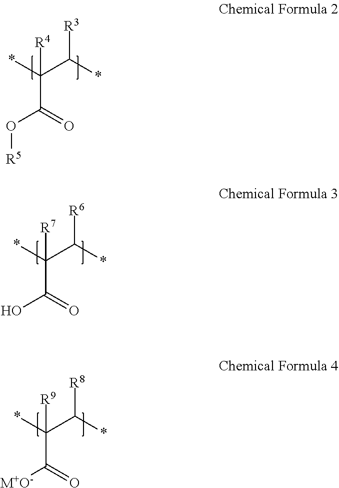

in Chemical Formulas 2, 3, and 4, R³, R⁴, R⁶, R⁷, R⁸, and R⁹ each independently are or include hydrogen or a methyl group, R⁵ is or includes a substituted or unsubstituted C1 to C20 alkyl group, and M is or includes an alkali metal.

The alkali metal may be or include, for example, at least one of lithium, sodium, potassium, rubidium, or cesium.

The structural unit derived from (meth)acrylate may be derived from at least one of (meth)acrylic acid alkyl esters, (meth)acrylic acid perfluoroalkyl esters, and (meth)acrylate having a functional group in a side chain, and for example, may be derived from a (meth)acrylic acid alkyl ester. In addition, the carbon number of an alkyl group or perfluoroalkyl group bonded to the non-carbonyl oxygen atom of the (meth)acrylic acid alkyl ester or the (meth)acrylic acid perfluoroalkyl ester may range from 1 to 20, for example, from 1 to 10, for example, from 1 to 5.

Examples of (meth)acrylic acid alkyl esters in which the alkyl group or perfluoroalkyl group bonded to the non-carbonyl oxygen atom has 1 to 5 carbon atoms may include acrylic acid alkyl esters such as at least one of methyl acrylate, ethyl acrylate, n-propyl acrylate, isopropyl acrylate, n-butyl acrylate, or t-butyl acrylate; acrylic acid-2-(perfluoroalkyl)ethyls such as at least one of acrylic acid-2-(perfluorobutyl)ethyl or acrylic acid-2-(perfluoropentyl)ethyl; alkyl methacrylates such as at least one of methyl methacrylate, ethyl methacrylate, n-propyl methacrylate, isopropyl methacrylate, n-butyl methacrylate, and t-butyl methacrylate; and methacrylic acid-2-(perfluoroalkyl)ethyls such as at least one of methacrylic acid-2-(perfluorobutyl)ethyl or acid-2-(perfluoropentyl)ethyl.

Examples of other (meth)acrylic acid alkyl esters may include acrylic acid alkyl esters having 6 to 18 carbon atoms in the alkyl group bonded to the non-carbonyl oxygen atom such as at least one of acrylic acid n-hexyl, acrylic acid-2-ethylhexyl, acrylic acid nonyl, acrylic acid lauryl, acrylic acid stearyl, acrylic acid cyclohexyl, or acrylic acid isobornyl; methacrylic acid alkyl esters having 6 to 18 carbon atoms in the alkyl group bonded to the non-carbonyl oxygen atom such as at least one of methacrylic acid n-hexyl, methacrylic acid-2-ethylhexyl, methacrylic acid octyl, methacrylic acid isodecyl, methacrylic acid lauryl, methacrylic acid tridecyl, methacrylic acid stearyl, or methacrylic acid cyclohexyl; acrylic acid-2-(perfluoroalkyl)ethyls having 6 to 18 carbon atoms in the perfluoroalkyl group bonded to the non-carbonyl oxygen atom such as at least one of acrylic acid-2-(perfluorohexyl)ethyl, acrylic acid-2-(perfluorooctyl)ethyl, acrylic acid-2-(perfluoronitrile)ethyl, acrylic acid-2-(perfluorodecyl)ethyl, acrylic acid-2-(perfluorodecyl)ethyl, acrylic acid-2-(perfluorotetradecyl)ethyl, or acrylic acid-2-(perfluorokexadecyl)ethyl; and methacrylic acid-2-(perfluoroalkyl)ethyls having 6 to 18 carbon atoms in the perfluoroalkyl group bonded to the non-carbonyl oxygen atom such as at least one of methacrylic acid-2-(perfluorohexyl)ethyl, methacrylic acid-2-(perfluorooctyl)ethyl, methacrylic acid-2-(perfluoronyl)ethyl, methacrylic acid-2-(perfluorodecyl)ethyl, methacrylic acid-2-(perfluorododecyl)ethyl, methacrylic acid-2-(perfluorotetradecyl)ethyl, or methacrylic acid-2-(perfluorohexadecyl)ethyl.

The structural unit derived from (meth)acrylic acid, (meth)acrylate, or a salt thereof may include one or all of the structural unit represented by Chemical Formula 2, the structural unit represented by Chemical Formula 3, and the structural unit represented by Chemical Formula 4, and when all are included, the structural unit represented by Chemical Formula 2, the structural unit represented by Chemical Formula 3, and the structural unit represented by Chemical Formula 4 may be contained in a molar ratio ranging from about 10:1 to about 1:1, for example, from 6:1 to 1:1, and for example, from 3:1 to 1:1.

The structural unit derived from (meth)acrylamido sulfonic acid or a salt thereof may be or include a structural unit derived from (meth)acrylamido sulfonic acid or (meth)acrylamido sulfonate, and the (meth)acrylamido sulfonate may be or include at least one of a conjugate base of (meth)acrylamido sulfonic acid, (meth)acrylamido sulfonate, or a derivative thereof. The structural unit derived from (meth)acrylamido sulfonic acid or (meth)acrylamido sulfonate may be, for example, represented by any one of Chemical Formulas 5, 6, 7, and a combination thereof below:

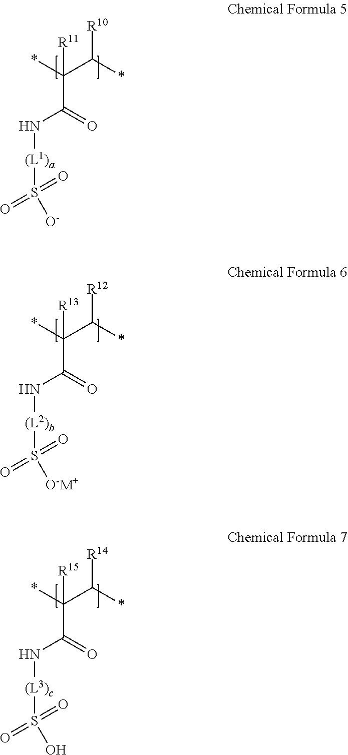

in Chemical Formulas 5 to 7, R¹⁰, R¹¹, R¹², R¹³, R¹⁴, and R¹⁵ may each independently be or include a hydrogen or methyl group,
L¹, L², and L³ may each independently be or include a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, and c may each be independently an integer ranging from 0 to 2, M may be or include an alkali metal, and the alkali metal may be or include, for example, at least one of lithium, sodium, potassium, rubidium, or cesium.

As an example, in Chemical Formulas 5 to 7, L¹, L², and L³ may each independently be or include a substituted or unsubstituted C1 to C10 alkylene groups, and a, b, and c may each be equal to 1.

The structural unit derived from (meth)acrylamido sulfonic acid or a salt thereof may include each, or two or more, of the structural unit represented by Chemical Formula 5, the structural unit represented by Chemical Formula 6, and the structural unit represented by Chemical Formula 7. As an example, the above structural unit may include the structural unit represented by Chemical Formula 6, and as another example, include the structural unit represented by Chemical Formula 6 and the structural unit represented by Chemical Formula 7 together.

When the structural unit represented by Chemical Formula 6 and the structural unit represented by Chemical Formula 7 are included together, a molar ratio of the structural unit represented by Chemical Formula 6 and the structural unit represented by Chemical Formula 7 may range from about 10:1 to about 1:2, for example, from 5:1 to 1:1, or for example from 3:1 to 1:1.

A sulfonate group in the structural unit derived from (meth)acrylamido sulfonic acid or a salt thereof may be or include, for example, at least one of vinyl sulfonic acid, allyl sulfonic acid, styrene sulfonic acid, anethole sulfonic acid, acrylamidoalkane sulfonic acid, sulfoalkyl (meth)acrylate, or a functional group derived from a salt thereof.

Herein, the alkane may be or include at least one of a C1 to C20 alkane, a C1 to C10 alkane, or a C1 to C6 alkane, and the alkyl may be or include at least one of a C1 to C20 alkyl, a C1 to C10 alkyl, or a C1 to C6 alkyl. The salt refers to a salt composed of the above-described sulfonic acid and a desired ion. The ion may be or include, for example, an alkali metal ion, and in this case, the salt may be or include a sulfonic acid alkali metal salt.

The (meth)acrylamidoalkane sulfonic acid may be or include, for example, at least one of 2-(meth)acrylamido-2-methylpropane sulfonic acid, and the sulfoalkyl (meth)acrylate may be or include, for example, at least one of 2-sulfoethyl(meth)acrylate, 3-sulfopropyl (meth)acrylate, and the like.

The (meth)acryl-based binder may be, for example, represented by Chemical Formula 8 below:

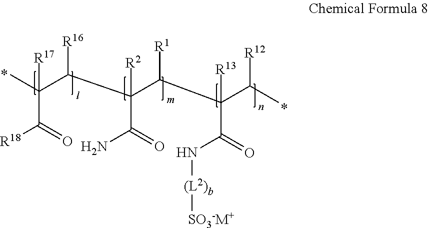

in Chemical Formula 8, R¹, R², R¹², R¹³, R¹⁶, and R¹⁷ each independently are or include a hydrogen or methyl group,
R¹⁸ is or includes OR or O⁻M⁺, wherein R is or includes hydrogen or a C1 to C6 alkyl group, M is or includes an alkali metal,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, b is an integer ranging from 0 to 2, M is or includes an alkali metal, and l, m and n denotes a molar ratio of each unit.

The alkali metal may be or include, for example, at least one of lithium, sodium, potassium, rubidium, or cesium.

As an example, in Chemical Formula 8, l+m+n=1. In addition, as an example, 0.05≤(l+n)≤0.45 and 0.55≤m≤0.95, for example, 0≤l≤0.4 and 0≤n≤0.1, for example, 0.8≤m≤0.9, 0≤l≤0.1, and 0≤n≤0.1, or for example, 0.8≤m≤0.9, 0.01≤l≤0.1, and 0.01≤n≤0.1.

As an example, in Chemical Formula 8, L² may be or include at least one of a substituted or unsubstituted C1 to C10 alkylene group, and b may be equal to 1.

In the (meth)acryl-based binder, the structural unit substituted with an alkali metal (M⁺) may be present in an amount ranging from about 50 mol % to about 100 mol %, for example, from 60 to 90 mol % or from 70 to 90 mol % with respect to 100 mol % of the total amount of (meth)acrylamido sulfonic acid structural unit. When any of the above ranges are satisfied, the (meth)acryl-based binder and the separator including the (meth)acryl-based binder can exhibit desired or improved bonding strength, heat resistance, and oxidation resistance.

The (meth)acryl-based binder may further include other units in addition to the above-described units. For example, the (meth)acryl-based binder may further contain at least one of a unit derived from an alkyl (meth)acrylate, a unit derived from a diene-based binder, a unit derived from a styrene-based binder, an ester group-containing unit, a carbonate group-containing unit, or a combination thereof.

The (meth)acryl-based binder may be in various forms, such as an alternating polymer in which the units are alternately distributed, a random polymer in which the units are randomly distributed, or a graft polymer in which some structural units are grafted.

A weight average molecular weight of the (meth)acryl-based binder may range from about 350,000 to about 970,000, for example, from 450,000 to 970,000 or from 450,000 to 700,000. When the weight average molecular weight of the (meth)acryl-based binder satisfies the above range, the (meth)acryl-based binder and the separator including the (meth)acryl-based binder can exhibit a desired or improved bonding strength, heat resistance, and air permeability. The weight average molecular weight may be or include a polystyrene-converted average molecular weight measured using gel permeation chromatography.

The (meth)acryl-based binder may be prepared by various known methods such as, e.g., emulsion polymerization, suspension polymerization, bulk polymerization, or solution polymerization.

The (meth)acryl-based binder may be prepared by a solution polymerization method.

According to an example embodiment, the (meth)acryl-based binder may be contained in the coating layer of the separator in the form of a film.

The cross-linking agent includes an aziridine-based cross-linking agent. The aziridine-based cross-linking agent may be configured to crosslink the (meth)acryl-based binder and to allow the separator to readily satisfy the above dry shrinkage ratio and shrinkage ratio ranges in the electrolyte.

The aziridine-based cross-linking agent may be or include a bi-functional or higher aziridine-based cross-linking agent. Herein, “bi-functional or higher” means that two or more aziridine groups are present in a molecule. According to an example embodiment, the aziridine-based cross-linking agent may be or include a bi- or tri-functional aziridine-based cross-linking agent.

For example, the aziridine-based cross-linking agent may include one or more of N,N′-toluene-2,4-bis(1-aziridinecarboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

The cross-linking agent, for example, the aziridine-based cross-linking agent, may be included in a desired amount with respect to the binder, for example, the (meth)acryl-based binder. According to an example embodiment, the aziridine-based cross-linking agent may be contained in an amount ranging from about 5 wt % to about 50 wt %, for example, for example 5, 10, 15, 20, 25, 30, 35, 40, 45, 50 wt %, from 10 to 40 wt %, or for example, from 10 to 20 wt % with respect to the content of the (meth)acryl-based binder. Within the above range, the shrinkage ratio in the electrolyte can be reduced.

The filler has a particle diameter D100 of about 1.0 μm or less. Within the above range, the separator may readily satisfy the dry shrinkage ratio and the shrinkage ratio in the electrolyte when the (meth)acryl-based binder is combined with the aziridine-based cross-linking agent. For example, the filler may have a particle diameter D100 of about 0.05 μm, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0 μm, a range of about 0.5 μm to about 0.8 μm, for example, a range of about 0.5 μm to about 0.7 μm.

According to an example embodiment, the filler may have a particle diameter D50 of about 0.5 μm or less, for example, 0.05, 0.1, 0.15, 0.2, 0.25, 0.3, 0.35, 0.4, 0.45, 0.5 μm, 0.4 μm or less, or for example, ranging from about 0.2 μm to about 0.35 μm. Within any of the above ranges, the shrinkage ratio in the electrolyte can be reduced.

The filler may be or include, for example, at least one of an inorganic filler, an organic filler, an organic-inorganic composite filler, or a combination thereof. The inorganic filler may be or include a ceramic material that can increase heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. The organic filler may include at least one of an acrylic compound, an imide compound, an amide compound, or a combination thereof, but is not limited thereto. The organic filler may have a core-shell structure, but is not limited thereto.

The filler may be substantially spherical, substantially plate-shaped, substantially cubic, or amorphous. For example, the filler may be plate-shaped.

The filler may be included in a desired amount with respect to the binder, for example, the (meth)acryl-based binder. According to an example embodiment, the (meth)acryl-based binder:filler mass ratio may range from about 1:10 to about 1:50, for example, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, from 1:20 to 1:30. Within the above range, the dry shrinkage ratio and the shrinkage ratio in the electrolyte can be reduced.

The filler may be contained in an amount ranging from about 50 wt % to about 99 wt %, for example, from 70 wt % to 99 wt %, for example, from 75 wt % to 99 wt %, for example, from 80 wt % to 99 wt %, for example, from 85 wt % to 99 wt %, for example, from 90 wt % to 99 wt %, or for example, from 95 wt % to 99 wt % of the total amount of the coating layer. When the filler is included within the above range, the separator can exhibit desired or improved heat resistance, durability, oxidation resistance, and stability.

The adhesive binder is or includes a swellable adhesive binder. Since the swellable adhesive binder is a binder with desired or improved heat resistance and bonding strength, the coating layer can exhibit both heat resistance and bonding strength with one layer.

In the coating layer, the swellable adhesive binder may be more relatively distributed in an upper portion of the coating layer, and the cross-linked product of the (meth)acryl-based binder, the filler, and the aziridine-based cross-linking agent may be more relatively distributed in a lower portion thereof. This is due to differences in the particle diameter D50 of the swellable adhesive binder and densities of the swellable adhesive binder and the filler.

The relative distribution of the swellable adhesive binder and the filler in the coating layer is merely different, and phases thereof are not completely separated. Therefore, the coating layer differs from a coating layer having a multilayered structure of two or more layers.

Generally known adhesive binders can exhibit wet bonding strength only under high temperature and high pressure conditions.

Prismatic rechargeable lithium batteries are manufactured by inserting a jelly roll in which a laminate of a positive electrode/separator/negative electrode is wound into a prismatic can, and then injecting an electrolyte therein, and high temperature and high pressure conditions may not be applied during and/or after this manufacturing process. Therefore, when commonly known binders are included in prismatic rechargeable lithium batteries, wet bonding strength is not secured.

In various examples, the swellable adhesive binder includes a first structural unit derived from a vinyl aromatic-based monomer, a second structural unit derived from an alkyl (meth)acrylate, and a third structural unit derived from a phosphonate-based monomer, and thus can exhibit a wet bonding strength even under low temperature and low pressure conditions.

According to an example embodiment, after the separator is subjected to a low temperature and low pressure process, it is possible to secure a wet bonding strength of about 0.05 gf/mm or more, for example, 0.05 gr/mm to 0.5 gf/mm between the separator and the negative electrode. Therefore, the separator can improve the high-temperature charge/discharge and/or storage characteristics of the rechargeable lithium battery.

Therefore, the separator according to an example embodiment can achieve a wet bonding strength even under low temperature and low pressure conditions during the manufacturing process (e.g., a chemical conversion process) of a prismatic rechargeable lithium battery.

The first structural unit derived from the vinyl aromatic-based monomer may be represented by Chemical Formula 9 below. The second structural unit derived from the alkyl (meth)acrylate may be represented by Chemical Formula 10 below. The third structural unit derived from the phosphonate monomer may be represented by Chemical Formula 11 below.

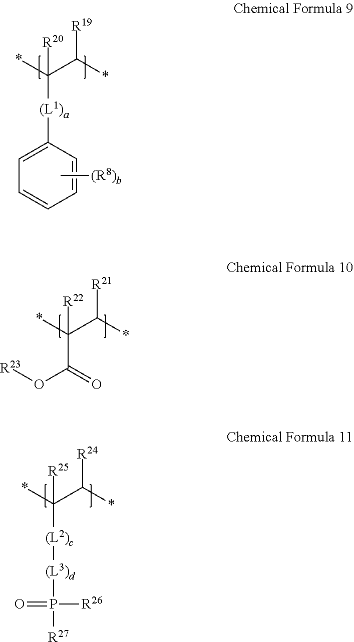

Descriptions of Chemical Formulas 9 to 11 are as follows:
R¹⁹, R²⁰, R²¹, R²², R²⁴, and R²⁵ each independently are or include hydrogen or a C1 to C6 alkyl group. For example, R¹⁹, R²⁰, R²¹, R²², R²⁴, and R²⁵ may be or include hydrogen or a methyl group.
R⁸ may be or include fluorine, a substituted or unsubstituted C1 to C6 alkyl group, a substituted or unsubstituted C6 to C20 aryl group, or a substituted or unsubstituted C1 to C6 alkenyl group.
R²³ may be or include a substituted or unsubstituted C1 to C20 alkyl group. For example, R²³ is or includes a branched substituted or unsubstituted C1 to C20 alkyl group and may be or include an ethylhexyl group.
L¹ may be or include at least one of a substituted or unsubstituted C1 to C6 alkylene group, a substituted or unsubstituted C3 to C10 cycloalkylene group, a substituted or unsubstituted C6 to C20 arylene group, or a combination thereof.
L² and L³ may each independently be or include at least one of a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, a substituted or unsubstituted C6 to C20 arylene group, or a combination thereof. For example, L² may be or include a carboxyl group (—C(═O)O—). For example, L³ may be or include a substituted or unsubstituted C1 to C6 alkylene group or a methylene group.
R²⁶ and R²⁷ may each independently be or include a substituted or unsubstituted C1 to C10 alkoxy group or a substituted or unsubstituted C6 to C20 aryloxy group. For example, R²⁶ and R²⁷ may both be or include a substituted or unsubstituted C1 to C10 alkoxy group or a methoxy group.
a, c, and d may each independently be or include an integer ranging from 0 to 2, and b may be an integer ranging from 0 to 5. For example, a may be equal to 0, b may be equal to 0, c may be equal to 1, and d may be equal to 1.

The swellable adhesive binder is in a particle form and can maintain the particle form without being dissolved in an aqueous solvent.

For example, the swellable adhesive binder may be or include a particle with a core-shell structure. The particle with the core-shell structure may be advantageous in securing a desired particle diameter D50 and swelling degree.

Components of the core are not particularly limited and may be or include, for example, at least one of a (meth)acrylic polymer, a diene polymer, or a mixture or copolymer thereof. For example, the core may be or include a copolymer of one or more of an alkyl (meth)acrylate and a vinyl aromatic-based monomer.

The shell may include the first structural unit derived from the vinyl aromatic-based monomer, the second structural unit derived from the alkyl (meth)acrylate, and the third structural unit derived from the phosphonate-based monomer.

According to an example embodiment, with respect to 100 wt % of the shell, the first structural unit may be contained in an amount ranging from about 40 wt % to about 90 wt % or from 50 wt % to 80 wt %, the second structural unit may be contained in an amount ranging from about 5 wt % to about 40 wt % or from 10 wt % to 30 wt %, the third structural unit may be contained in an amount ranging from about 0.1 wt % to about 20 wt % or 5 wt % to 20 wt %. Within the above ranges, the coating layer can realize an desired or improved bonding strength even with a small thickness without degrading the heat resistance of the separator.

The particle diameter D50 of the swellable adhesive binder may range from about 0.1 μm to about 1 μm, for example 0.1, 0.2, 0.3, 0.4, 0.5, 0.6, 0.7, 0.8, 0.9, 1.0 μm, from 0.2 μm to 0.9 μm, from 0.2 μm to 0.8 μm, or from 0.2 μm to 0.7 μm. Within the above range, the coating layer can realize an desired or improved bonding strength even with a small thickness without degrading the heat resistance of the separator.

A glass transition temperature of the swellable adhesive binder may range from about 60° C. to about 120° C., for example 60, 65, 70, 75, 80, 85, 90, 95, 100, 105, 110, 115, 120° C., from 60° C. to 90° C., or from 60° C. to 75° C. Within the above range, the swellable adhesive binder can be advantageous for exhibiting wet bonding strength even under low temperature and low pressure conditions, and the coating layer can realize an desired or improved bonding strength even with a small thickness without degrading the heat resistance of the separator.

The swellable adhesive binder may expand about 2 to about 1000 times, 3 to 1000 times, or 6 to 1000 times, for example 2, 3, 4, 5, 6, 7, 8, 9, 10, 15, 20, 25, 30, 35, 40, 45, 50, 55, 60, 65, 70, 75, 80, 85, 90, 95, 100, 150, 200, 250, 300, 350, 400, 450, 500, 550, 600, 650, 700, 750, 800, 850, 900, 950, 1000, of an initial volume after being left at about 60° C. for about 72 hours. Within the above range, the swellable adhesive binder can be advantageous for exhibiting wet bonding strength even under low temperature and low pressure conditions, and the coating layer can realize a desired or improved bonding strength even with a small thickness without degrading the heat resistance and air permeability of the separator. A composition of the electrolyte is according to the Examples further discussed below.

A weight average molecular weight of the swellable adhesive binder may range from about 100,000 g/mol to about 800,000 g/mol or from 300,000 g/mol to 500,000 g/mol.

The swellable adhesive binder may be included in a desired amount with respect to the binder, for example, the (meth)acryl-based binder.

According to an example embodiment, the adhesive binder, for example, the swellable adhesive binder may be contained in an amount ranging from about 5 wt % to 50 wt %, for example, 5, 10, 15, 20, 25, 30, 35, 40, 45, 50 wt %, 10 to 40 wt %, for example, 10 wt % to 30 wt % or 10 wt % to 20 wt % with respect to the content of the (meth)acryl-based binder. Within the above range, it is possible to increase the yield in the electrolyte.

The swellable adhesive binder can be readily prepared according to methods of manufacturing core-shell particles known to those skilled in the art.

In the coating layer, the loading amount of the swellable adhesive binder may range from about 0.05 g/m² to 1 g/m².

The adhesive binder may be contained in an amount ranging from about 1 wt % to 20 wt %, for example, 1, 2, 3, 4, 5, 6, 7, 8, 9, 10, 11, 12, 13, 14, 15, 16, 17, 18, 19, 20 wt %, 5 to 20 wt %, for example, 5 wt % to 15 wt % with respect to the total amount of the coating layer. Within the above range, the bonding strength to the electrode can be exhibited, and battery resistance does not increase, and thus there may be no limit to capacity implementation.

The coating layer may have a thickness ranging from about 0.01 μm to about 20 μm, and within the above range, may have a thickness ranging from about 1 μm to 10 μm, about 1 μm to 5 μm, or about 1 μm to 3 μm.

A ratio of the thickness of the coating layer to the thickness of the porous substrate may range from about 0.05 to about 0.5, for example, from 0.05 to 0.4, from 0.05 to 0.3, or from 0.1 to 0.2. Within the above range, the separator can exhibit desired or improved air permeability, heat resistance, and bonding strength. Herein, “thickness of the coating layer” indicates a thickness of one coating layer when the coating layer is formed on only one surface of the porous substrate and a thickness of two coating layers when the coating layer is formed on both surfaces of the porous substrate.

### Porous Substrate

The porous substrate may be or include a substrate having multiple pores that is commonly present in electrochemical devices. The porous substrate may be or include a polymer membrane formed of or including any one polymer such as or including at least one of a polyolefin such as polyethylene or polypropylene, a polyester such as polyethylene terephthalate or polybutylene terephthalate, polyacetal, polyamide, polyimide, polycarbonate, polyether ether ketone, polyaryl ether ketone, polyetherimide, polyamideimide, polybenzimidazole, polyethersulfone, polyphenylene oxide, a cyclic olefin copolymer, polyphenylene sulfide, polyethylene naphthalate, glass fiber, Teflon, and polytetrafluoroethylene, or a copolymer or mixture of two or more types thereof.

The porous substrate may be or include, for example, a polyolefin-based substrate containing a polyolefin, and the polyolefin-based substrate may have an desired or improved shutdown function, thereby contributing to increasing the safety of the battery. The polyolefin-based substrate may be or include, for example, at least one of a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or include a copolymer of olefin and non-olefin monomers.

The porous substrate may have a thickness ranging from about 1 μm to about 40 μm, for example, from 1 μm to 30 μm, from 1 μm to 20 μm, or from 5 μm to 15 μm.

The separator for a rechargeable lithium battery according to an example embodiment may have desired or improved wet bonding strength. For example, the separator for a rechargeable lithium battery may have a bonding strength of about 0.05 gf/mm or more, for example, ranging from 0.05 gf/mm to 0.1 gf/mm, for example, from 0.05 gf/mm to 0.2 gf/mm.

The separator for a rechargeable lithium battery according to an example embodiment may exhibit desired or improved air permeability and have an air permeability value of, for example, less than about 200 sec/100 cc, for example, 190 sec/100 cc or less, or 180 sec/100 cc or less. That is, the separator may have an air permeability value of less than about 40 sec/100 cc·1 μm per unit thickness, for example, 30 sec/100 cc·1 μm or less, or 25 sec/100 cc·1 μm or less. Herein, the air permeability refers to the time (seconds) it takes for 100 cc of air to pass through the unit thickness of the separator. The air permeability per unit thickness may be obtained by measuring the air permeability for the total thickness of the separator and dividing the air permeability by the thickness. The air permeability may be obtained by measuring the time it takes for 100 cc of air to pass through the separator using an air permeability measurement device (EG01-55-1MR, Asahi Seiko Co., Ltd.).

The separator for a rechargeable lithium battery according to an example embodiment may be formed by applying a composition for forming a coating layer on one surface or both surfaces of a porous substrate, drying, and then curing the composition. The curing may be performed using conventional methods known to those skilled in the art.

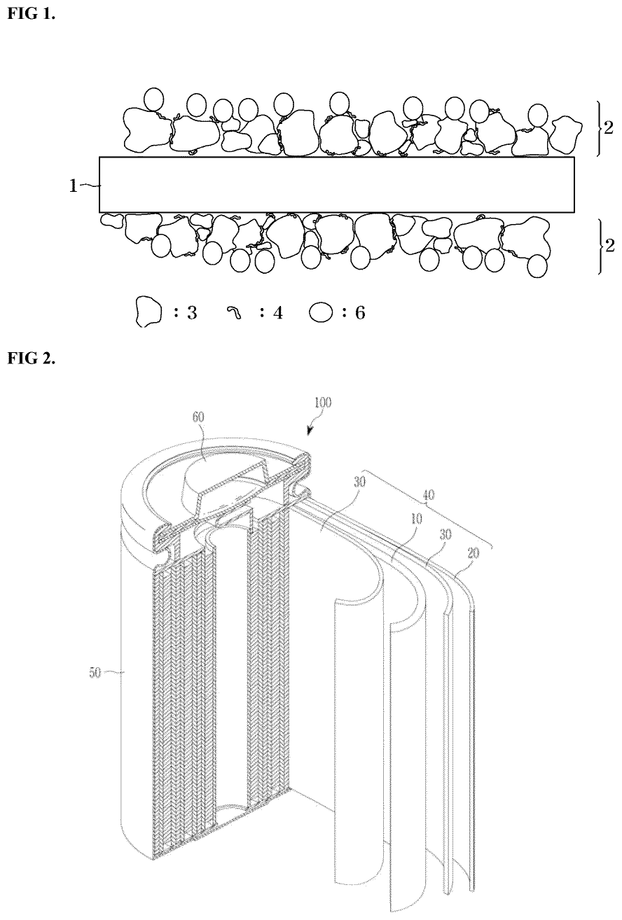

FIG. 1 is a cross-sectional view illustrating a separator for a rechargeable lithium battery according to an example embodiment. Referring to FIG. 1, the separator for a rechargeable lithium battery includes a porous substrate 1 and a coating layer 2 located on both surfaces of the porous substrate 1. The coating layer 2 may include a filler 3, a cross-linked product 4 of a (meth)acryl-based binder and a cross-linking agent, and an adhesive binder 6.

### Rechargeable Lithium Battery

According to an example embodiment, the rechargeable lithium battery includes the separator for a rechargeable lithium battery, a positive electrode, and a negative electrode.

The separator for rechargeable lithium battery refers to the description described above. The separator for rechargeable lithium battery may be located between the positive electrode and the negative electrode.

### Positive Electrode

A positive electrode for a rechargeable lithium battery may include a current collector and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0≤α≤2); LiₐNi_{b}Co_{c}L¹_{d}G_{c}O₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiaCoGbO₂ (0.90≤a≤1.8 and 0.001≤b≤0.1); LiₐMn_{1-b}GbO₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄ (0.90≤a≤1.8).

In the above Chemical Formulas, A is or includes at least one of Ni, Co, Mn, or a combination thereof, X is or includes at least one of Al, Ni, Co, Mn, Cr, Fe, Mg, Sr, V, a rare earth element or a combination thereof, D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder is configured to attach the positive electrode active material particles to each other, and also to attach the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be configured to impart conductivity (e.g., electrical conductivity) to the electrode. Any material that does not cause chemical change (e.g., that does not cause an undesirable chemical change in the rechargeable lithium battery), and that conducts electrons, can be included in the battery. Examples of the conductive material may include a carbon-based material such as or including at least one of natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as or including a polyphenylene derivative; or a mixture thereof.

Al may be included as the current collector, but is not limited thereto.

### Negative Electrode

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, at least one of crystalline carbon, amorphous carbon or a combination thereof. The crystalline carbon may be or include graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be combined with a carbon-based negative electrode active material.

The binder may be configured to attach the negative electrode active material particles to each other, and to attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may be configured to impart conductivity (e.g., electrical conductivity) to the electrode. Any material that does not cause chemical change (e.g., that does not cause an undesirable chemical change in the rechargeable lithium battery), and that conducts electrons, can be included in the battery. Non-limiting examples thereof may include a carbon-based material such as or including at least one of natural graphite, artificial graphite, carbon black, acetylene black, ketjen black, a carbon fiber, a carbon nanofiber, and a carbon nanotube; a metal-based material including at least one of copper, nickel, aluminum, silver, etc. in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R-CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

The rechargeable lithium battery may be classified into cylindrical, prismatic, pouch, or coin-type batteries, and the like depending on their shape.

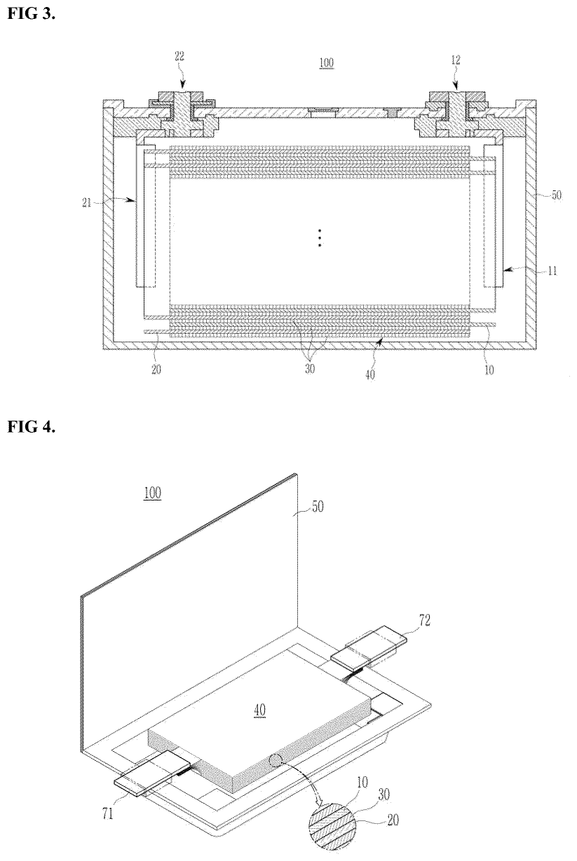

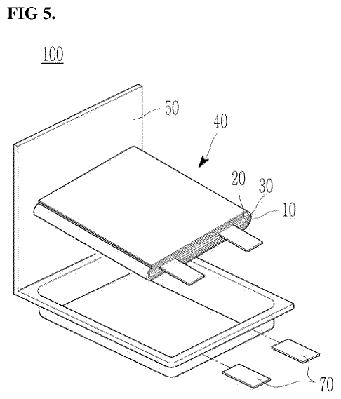

FIGS. 2-5 are schematic views illustrating a rechargeable lithium battery according to an example embodiment. FIG. 2 illustrates a cylindrical battery, FIG. 3 illustrates a prismatic battery, and FIGS. 4 and 5 illustrate pouch-type batteries. Referring to FIGS. 2-5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 2. In FIG. 3, the rechargeable lithium battery 100 may include a positive lead tab 11, a positive terminal 12, a negative lead tab 21, and a negative terminal 22. As shown in FIGS. 4 and 5, the rechargeable lithium battery 100 may include an electrode tab 70 illustrated in FIG. 5, or, for example, a positive electrode tab 71 and a negative electrode tab 72 illustrated in FIG. 4, the electrode tabs 70/71/72 forming an electrical path for inducing the current formed in the electrode assembly 40 to the outside of the battery 100.

The rechargeable lithium battery according to an example embodiment may be applicable to automobiles, mobile phones, and/or various types of electric devices, as non-limiting examples.

The following Examples and Comparative Examples are provided in order to highlight characteristics of one or more example embodiments, but it is understood that the Examples and Comparative Examples are not to be construed as limiting the scope of the example embodiments, nor are the Comparative Examples to be construed as being outside the scope of the example embodiments. Further, it is understood that the example embodiments are not limited to the particular details described in the Examples and Comparative Examples.

### Preparation Example 1

In a 10 L four-necked flask provided with a stirrer, a thermometer, and a cooling tube, a process of adding distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and a 5N aqueous lithium hydroxide solution (1.05 equivalents with respect to the total amount of 2-acrylamido-2-methylpropanesulfonic acid), then reducing an internal pressure to 10 mmHg using a diaphragm pump, and returning the internal pressure to a normal pressure using nitrogen was repeated three times.

The reaction was carried out for 12 hours while controlling the temperature of the reaction solution to be stable between 65° C. and 70° C. After cooling to room temperature, the pH of the reaction solution was adjusted to 7 to 8 using a 25% aqueous ammonia solution.

Accordingly, poly(acrylic acid-co-acrylamide-co-2-acrylamido-2-methylpropanesulfonic acid) lithium salt was prepared. A molar ratio of the structural unit derived from acrylic acid, the structural unit derived from acrylamide, and the structural unit derived from 2-acrylamido-2-methylpropanesulfonic acid was 10:85:5. A non-volatile component in about 10 mL of the reaction solution (reaction product) was measured, and the measurement result was 9.5 wt % (theoretical value: 10%).

### Preparation Example 2

An acryl-based binder was prepared in the same manner as Preparation Example 1, with a difference that acrylic acid and acrylamide were used and 2-acrylamido-2-methylpropane sulfonic acid was not used. A molar ratio of acrylic acid and acrylamide was 42:58. The non-volatile component of the reaction solution was 9.0 wt % (theoretical value: 10%).

### Preparation Example 3

An acryl-based binder was prepared in the same manner as Preparation Example 1, with a difference that acrylic acid and 2-acrylamido-2-methylpropane sulfonic acid were used and acrylamide was not used. A molar ratio of acrylic acid and 2-acrylamido-2-methylpropane sulfonic acid was 74:26. The non-volatile component of the reaction solution was 9.0 wt % (theoretical value: 10%).

### Preparation Example 4

An acryl-based binder was prepared in the same manner as Preparation Example 1, with a difference that acrylamide and 2-acrylamido-2-methylpropane sulfonic acid were used and acrylic acid was not used. A molar ratio of acrylamide and 2-acrylamido-2-methylpropane sulfonic acid was 74:26. The non-volatile component of the reaction solution was 9.0 wt % (theoretical value: 10%).

### Preparation Example 5

A swellable adhesive binder was prepared. The swellable adhesive binder has a core-shell particle form, the core is a copolymer of an alkyl acrylate and divinylbenzene, and the shell is a copolymer of 70 wt % styrene, 20 wt % 2-ethylhexyl methacrylate, and 10 wt % dimethyl[(acryloyloxy)methyl]phosphonate, the particle diameter D50 is 0.5 μm, the glass transition temperature is 90° C., and the swelling degree is 3 times.

The above “swelling degree” refers to the degree of swelling compared to an initial volume after adding the binder to the electrolyte and leaving the same at 60° C. for 72 hours. The electrolyte contains LiPF₆ at a concentration of 1.3 M and is a mixed solution of ethyl carbonate (EC)/ethyl methyl carbonate (EMC)/diethyl carbonate (DEC) (volume ratio of 3/5/2).

### Example 1

A dispersion was prepared by mixing an acryl-based binder (10 wt % in distilled water) prepared in Preparation Example 1 and boehmite (particle diameter D100: 0.5 μm, particle diameter D50: 0.2 μm, plate-shaped) as a filler at a mass ratio of acryl-based binder:filler=1 part by weight: 30 parts by weight based on solid content, adding the mixture to a water solvent, then milling the same for 30 minutes at 25° C. using a bead mill, and dispersing the same.

A composition for forming a coating layer was prepared by adding trimethylolpropane tris(2-methyl-1-aziridine propionate (tri-functional aziridine-based cross-linking agent) as an aziridine-based cross-linking agent in an amount of 0.1 part by weight (content of 10 wt % of the acryl-based binder) based on solid content to the dispersion, adding the adhesive binder prepared in Preparation Example 5 in an amount of 0.1 part by weight (content of 10 wt % of the acryl-based binder) based on solid content, and adding water so that the total solid content became 20 wt %.

The composition for forming a coating layer was respectively coated to a thickness of 1.5 μm on both sides of a polyethylene film (thickness: 8 μm, SK Company, air permeability: 120 sec/100 cc, puncture strength: 480 kgf) as a porous substrate by die coating. A separator for a lithium secondary battery was manufactured by drying and aging in an oven at 80° C. for 16 hours.

### Examples 2 to 8

A separator for a rechargeable lithium battery was manufactured in the same manner as in Example 1, with a difference that in Example 1, as shown in Table 1 below, boehmite was used as a filler, but the D50 and D100 was changed, the mass ratio of the acryl-based binder:filler was changed, and the content of the aziridine-based cross-linking agent was changed.

### Comparative Examples 1 to 5

A separator for a rechargeable lithium battery was manufactured in the same manner as in Example 1, with a difference that in Example 1, as shown in Table 1 below, the D50 and D100 of the filler, the type of the cross-linking agent, the content of the cross-linking agent, the mass ratio of the (meth)acryl-based binder:filler, the content of the adhesive binder, etc. were changed. PVA is a homopolymer of polyvinyl alcohol. An epoxy-based cross-linking agent is ethylene glycol diglycidyl ether.

The following physical properties of the separators manufactured in Examples and Comparative Examples were evaluated, and the results are shown in Table 2 below.

### Dry Shrinkage Ratio (Units: %):

Samples were manufactured by cutting the separators for a rechargeable lithium battery of Examples and Comparative Examples to a size of 8 cm×8 cm. A shrinkage ratio in each of a mechanical direction (MD) and a transverse direction (TD) was calculated by drawing a square with a size of 5 cm×5 cm on surfaces on the samples, then putting the same between pieces of paper or alumina powder, leaving the same in an oven at 150° C. for 1 hour, taking the sample out, and then measuring the side dimensions of the drawn square. The shrinkage ratio was calculated according to Equation 1 below.

$$Shrinkage ratio = ( L 0 - L 1 ) / L 0 \times 100 \qquad Equation 1$$

L0 denotes an initial length of the separator, and L1 denotes a length of the separator after being left at 150° C. for 1 hour.

### Shrinkage Ratio in Electrolyte (Units: %):

Samples were manufactured by cutting the separators for a rechargeable lithium battery of Examples and Comparative Examples to a size of 5 cm×5 cm.

A positive electrode slurry was prepared by mixing 97 wt % LiCoNiAl as a positive electrode active material, 1.5 wt % carbon nanotubes, and 1.5 wt % polyvinyl fluoride as a conductive material and adding water thereto.

A positive electrode was manufactured by applying the prepared positive electrode slurry to aluminum foil and drying and rolling the same.

A negative electrode active material slurry was prepared by mixing 97.4 wt % negative electrode active material, 1.0 wt % carboxymethyl cellulose, 1.5 wt % styrene-butadiene-based rubber, and 0.1 wt % carbon nanotubes as a conductive agent. Artificial graphite was used as the negative electrode active material. A negative electrode was manufactured by applying the prepared negative electrode slurry to aluminum foil and drying and rolling the same.

One sample was located between the positive electrode and the negative electrode to form three sets of positive electrode-sample-negative electrode laminates, which were then put in a pouch. 3 g of an electrolyte (ethylene carbonate, ethyl methyl carbonate, and dimethyl carbonate (a volume ratio of 30:50:20 based on the total volume of 100) in which 1.5M LiPF₆ was dissolved) was injected to completely saturate the laminate with the electrolyte, which was sealed and left at 25° C. for 12 hours. A shrinkage ratio was calculated by leaving the laminate in the oven at 150° C. for 1 hour, then taking the sample out and cooling the sample, and then measuring the side dimensions of the sample. The shrinkage ratio was calculated according to Equation 1.

### Presence or Absence of Cross-Linking:

Samples were manufactured by cutting the separators for a rechargeable lithium battery of Examples and Comparative Examples to a size of 5 cm×5 cm. When the sample was fully immersed in deionized water at 25° C. and left for 25 hours, whether the filler was detached from the coating layer was visually checked. When the filler is not detached, it indicates that the coating layer composition is cross-linked, and when the filler is detached, it indicates that the coating layer composition is not cross-linked.

### Wet Bonding Strength (Units: Gf/Mm):

A rechargeable lithium battery was manufactured using the same manner as the above “Shrinkage ratio in electrolyte.”

The manufactured rechargeable lithium battery was left for 2 hours under conditions of a temperature of 40° C. and a load of 50 kg. The separator and the negative electrode were separated by about 10 mm to 20 mm, the negative electrode was fixed to a lower grip, the separator was fixed to an upper grip so that a gap between the grips was 20 mm, and the separator was stretched in a direction of 180° from the negative electrode at a speed of 100 mm/min. An arithmetic average was obtained by measuring a force required to peel 40 mm three times. A bonding strength was measured using a UTM.

### Battery Lifetime Characteristics (ΔT (Units: ° C.), Efficiency (Units: %)):

A slurry was prepared by adding LiCoO₂, polyvinylidene fluoride, and carbon black to an N-methylpyrrolidone solvent at a weight ratio of 96:2:2. A positive electrode was manufactured by applying the slurry to an aluminum thin film and drying and rolling the same.

A slurry was prepared by adding graphite, polyvinylidene fluoride, and carbon black to N-methylpyrrolidone solvent at a weight ratio of 98:1:1. A negative electrode was manufactured by applying the slurry to a copper foil and drying and rolling the same.

Jelly roll electrode assemblies in the form of winding were each manufactured by interposing each of the separators manufactured in Examples and Comparative Examples between the manufactured positive and negative electrodes. Rechargeable lithium batteries were each manufactured by injecting an electrolyte containing 1.15M LiPF₆ added to a solvent in which ethylene carbonate, ethyl methyl carbonate, and diethyl carbonate were mixed at a volume ratio of 3:5:2 into each of the manufactured electrode assemblies and sealing the same.

Initial charging/discharging was performed by charging the manufactured rechargeable lithium battery to an upper limit voltage of 4.25 V at a constant current of 0.1 C at 55° C., and then discharging the battery to a discharge termination voltage of 3.5V at a constant current of 0.1 C. Charging at 0.5 C and discharging at 0.5 C were repeated 10 times in a voltage range of 3.5 V to 4.25 V.

A temperature of the rechargeable lithium battery was measured after 10 cycles, and a degree of increase compared to the initial temperature was defined as ΔT. In addition, efficiency was calculated according to Equation 2 below:

$$Efficiency = ( discharge capacity after 10 cycles / discharge capacity after 1 cycle ) \times 100 \qquad Equation 2$$

TABLE 1

| | | | | | | Content | Presence | | | | | | | |
|---|---|---|---|---|---|---|---|---|---|---|---|---|---|---|
| | | | | | | of cross- | or | Dry | | Shrinkage | | | | |
| | | | | | Cross- | linking | absence | shrinkage | | ratio in | | Wet | Lifetime | |
| | Filler | | | | linking | agent | of cross- | ratio | | electrolyte | | bonding | characteristics | |
| | D50 | D100 | Binder:filler | Binder | agent | (wt %) | linking | MD | TD | MD | TD | strength | ΔT | Efficiency |
| Example 1 | 0.2 | 0.5 | 1:30 | Preparation | Aziridine- | 10 | Cross- | 3.5 | 3.5 | 13 | 14 | 0.14 | 4.0 | 98 |
| | | | | Example 1 | based | | linked | | | | | | | |
| Example 2 | 0.2 | 0.5 | 1:25 | Preparation | Aziridine- | 10 | Cross- | 3 | 3.5 | 9 | 11 | 0.15 | 2.5 | 98 |
| | | | | Example 1 | based | | linked | | | | | | | |
| Example 3 | 0.2 | 0.5 | 1:20 | Preparation | Aziridine- | 10 | Cross- | 2.5 | 2.5 | 3 | 3 | 0.18 | 2.1 | 98 |
| | | | | Example 1 | based | | linked | | | | | | | |
| Example 4 | 0.2 | 0.5 | 1:25 | Preparation | Aziridine- | 20 | Cross- | 3 | 3 | 9 | 10 | 0.15 | 2.5 | 97 |
| | | | | Example 1 | based | | linked | | | | | | | |
| Example 5 | 0.2 | 0.5 | 1:25 | Preparation | Aziridine- | 30 | Cross- | 3 | 3.5 | 8 | 8 | 0.15 | 3.0 | 95 |
| | | | | Example 1 | based | | linked | | | | | | | |
| Example 6 | 0.2 | 0.5 | 1:25 | Preparation | Aziridine- | 40 | Cross- | 3 | 3.5 | 6 | 8 | 0.15 | 3.0 | 95 |
| | | | | Example 1 | based | | linked | | | | | | | |
| Example 7 | 0.3 | 0.8 | 1:20 | Preparation | Aziridine- | 10 | Cross- | 3 | 3.5 | 10 | 12 | 0.18 | 2.5 | 98 |
| | | | | Example 1 | based | | linked | | | | | | | |
| Example 8 | 0.5 | 1.0 | 1:20 | Preparation | Aziridine- | 10 | Cross- | 4.5 | 4.5 | 15 | 16 | 0.18 | 3.0 | 97 |
| | | | | Example 1 | based | | linked | | | | | | | |
| Comparative | 0.2 | 0.5 | 1:20 | Preparation | — | — | Not | 2.5 | 2.5 | 43 | 47 | 0.18 | 2.3 | 98 |
| Example 1 | | | | Example 1 | | | cross- | | | | | | | |
| | | | | | | | linked | | | | | | | |
| Comparative | 0.6 | 1.3 | 1:20 | Preparation | Aziridine- | 10 | Cross- | 3.5 | 3.5 | 52 | 58 | 0.18 | 2.5 | 98 |
| Example 2 | | | | Example 1 | based | | linked | | | | | | | |
| Comparative | 0.2 | 0.5 | 1:20 | PVA | Aziridine- | 10 | Not | 10 | 15 | 51 | 55 | 0.18 | 2.5 | 98 |
| Example 3 | | | | | based | | cross- | | | | | | | |
| | | | | | | | linked | | | | | | | |
| Comparative | 0.2 | 0.5 | 1:30 | Preparation | Epoxy- | 10 | Cross- | 3.5 | 3.5 | 40 | 43 | 0.14 | 4.0 | 96 |
| Example 4 | | | | Example 1 | based | | linked | | | | | | | |
| Comparative | 0.2 | 0.5 | 1:30 | Preparation | Aziridine- | 10 | Cross- | 15 | 20 | 40 | 43 | 0.14 | 4.0 | 96 |
| Example 5 | | | | Example 3 | based | | linked | | | | | | | |

A separator for a rechargeable lithium battery according to the example embodiment can exhibit a significantly low dry shrinkage ratio and shrinkage ratio in an electrolyte, thereby increasing the stability of the battery, reducing a wet shrinkage ratio, and improving the high-temperature lifetime characteristics of the battery.

Although example embodiments of the present disclosure have been described above, the present disclosure is not limited thereto and may be modified in any form within the scope of the claims, the detailed description of the present disclosure, and the accompanying drawings, and the modifications also fall within the scope of the present disclosure.

What is claimed is:

1. A separator for a rechargeable lithium battery, the separator comprising:
a porous substrate; and
a coating layer located on at least one surface of the porous substrate,
wherein the coating layer includes a cross-linked product of a binder and a cross-linking agent, a filler, and an adhesive binder,
the binder includes a (meth)acryl-based binder including a first structural unit derived from (meth)acrylamide, and a second structural unit including at least one of a structural unit derived from (meth)acrylic acid or (meth)acrylate and a structural unit derived from (meth)acrylamido sulfonic acid or a salt thereof,
the cross-linking agent includes an aziridine-based cross-linking agent,
the filler has a particle diameter D100 of about 1.0 μm or less, and
the adhesive binder includes a first structural unit derived from a vinyl aromatic-based monomer, a second structural unit derived from an alkyl (meth)acrylate, and a third structural unit derived from a phosphonate-based monomer.

2. The separator of claim 1, wherein the coating layer is formed from a composition including the (meth)acryl-based binder, the aziridine-based cross-linking agent, the filler having the particle diameter D100 of about 1.0 μm or less, and the adhesive binder.

3. The separator of claim 1, wherein the coating layer includes a cross-linked product of a composition including the (meth)acryl-based binder, the aziridine-based cross-linking agent, the filler having the particle diameter D100 of about 1.0 μm or less, and the adhesive binder.

4. The separator of claim 1, wherein the aziridine-based cross-linking agent comprises one or more of N,N′-toluene-2,4-bis(1-aziridinecarboxamide), N,N′-(methylenedi-p-phenylene)bis(aziridine-1-carboxamide), triethylenemelamine, 1,1-isophthaloyl bis(2-methylaziridine), tris(1-aziridinyl)phosphine oxide, N,N-hexamethylene-bis(aziridine carboxamide), trimethylolpropane tris(2-methyl-1-aziridine propionate), trimethylolpropane tris(beta-N-aziridinyl)propionate, and pentaerythritol tris(3-(1-aziridinyl)propionate).

5. The separator of claim 1, wherein the aziridine-based cross-linking agent is included in an amount ranging from about 5 wt % to about 50 wt % with respect to a content of the (meth)acryl-based binder.

6. The separator of claim 1, wherein a mass ratio of the (meth)acryl-based binder to the filler ranges from about 1:10 to about 1:50.

7. The separator of claim 1, wherein the filler has a particle diameter D50 of about 0.5 μm or less.

8. The separator of claim 1, wherein the filler comprises a plate-shaped inorganic filler.

9. The separator of claim 1, wherein the first structural unit derived from the (meth)acrylamide is represented by Chemical Formula 1: 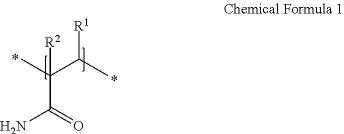
in Chemical Formula 1, R¹ and R² each independently comprises hydrogen or a methyl group,
the structural unit derived from the (meth)acrylic acid or (meth)acrylate is represented by any one of Chemical Formulas 2, 3, 4, and a combination thereof below: 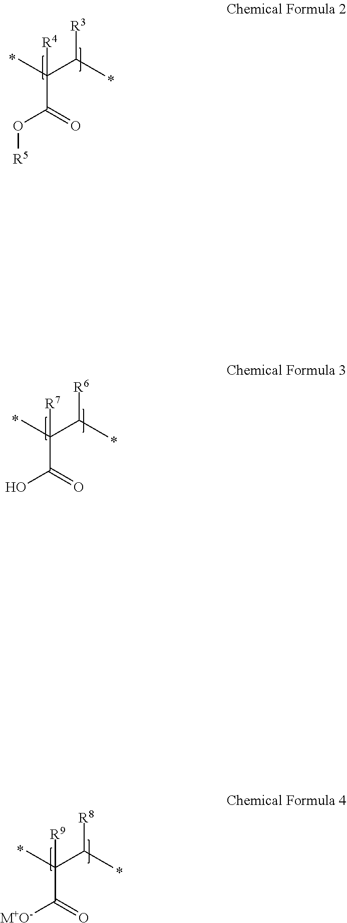
in Chemical Formulas 2, 3, and 4, R³, R⁴, R⁶, R⁷, R⁸, and R⁹ each independently comprises hydrogen or a methyl group, R⁵ comprises a substituted or unsubstituted C1 to C20 alkyl group, and M comprises an alkali metal, and
the structural unit derived from the (meth)acrylamido sulfonic acid or the salt thereof is represented by any one or more of Chemical Formulas 5, 6, 7: 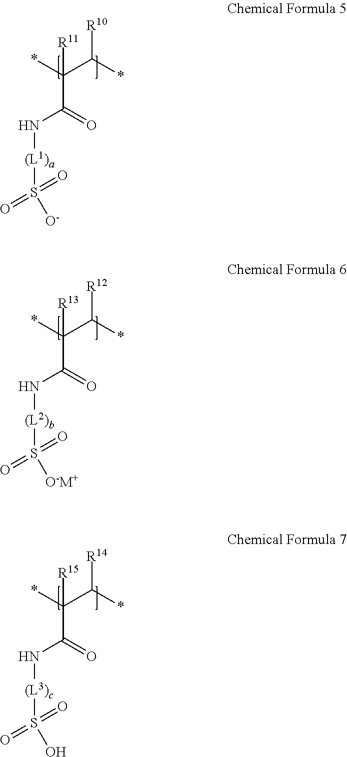
in Chemical Formulas 5 to 7,
R¹⁰, R¹¹, R¹², R¹³, R¹⁴, and R¹⁵ each independently comprises hydrogen or a methyl group,
L¹, L², and L³ each independently comprises a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
a, b, and c are each independently an integer ranging from 0 to 2, and M comprises an alkali metal.

10. The separator of claim 1, wherein the adhesive binder comprises a particle with a core-shell structure.

11. The separator of claim 1, wherein the adhesive binder comprises a swellable adhesive binder.

12. The separator of claim 1, wherein the first structural unit derived from the vinyl aromatic-based monomer is represented by Chemical Formula 9,
the second structural unit derived from the alkyl (meth)acrylate is represented by Chemical Formula 10, and
the third structural unit derived from the phosphonate monomer is represented by Chemical Formula 11: 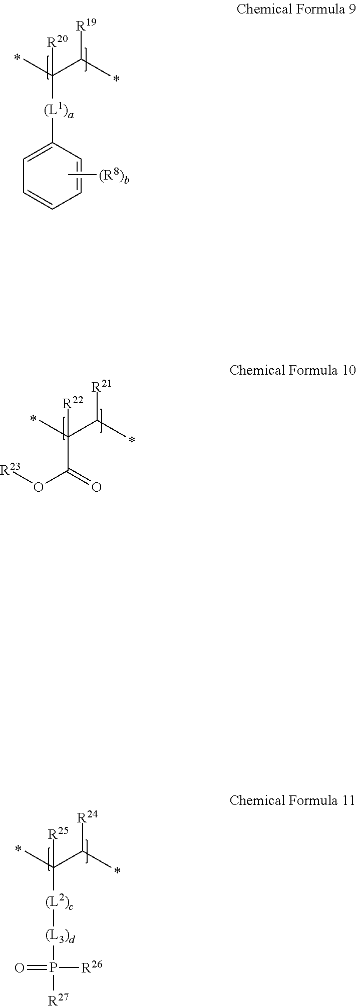
in Chemical Formulas 9 to 11,
R¹⁹, R²⁰, R²¹, R²², R²⁴, and R²⁵ each independently comprises hydrogen or a C1 to C6 alkyl group,
R⁸ comprises fluorine, a substituted or unsubstituted C1 to C6 alkyl group, a substituted or unsubstituted C6 to C20 aryl group, or a substituted or unsubstituted C1 to C6 alkenyl group,
R²³ comprises a substituted or unsubstituted C1 to C20 alkyl group,
L¹ comprises at least one of a substituted or unsubstituted C1 to C6 alkylene group, a substituted or unsubstituted C3 to C10 cycloalkylene group, and a substituted or unsubstituted C6 to C20 arylene group,
L² and L³ each independently comprises at least one of a carboxyl group (—C(═O)O—), a carbonyl group (—C(═O)—), an ether group (—O—), a substituted or unsubstituted C1 to C6 alkylene group, a substituted or unsubstituted C3 to C10 cycloalkylene group, and a substituted or unsubstituted C6 to C20 arylene group,
R²⁶ and R²⁷ each independently comprises a substituted or unsubstituted C1 to C10 alkoxy group or a substituted or unsubstituted C6 to C20 aryloxy group, and
a, c, and d are each independently an integer ranging from 0 to 2, and b is an integer ranging from 0 to 5.

13. The separator of claim 1, wherein the adhesive binder is included in an amount ranging from about 5 wt % to about 50 wt % with respect to a content of the (meth)acryl-based binder.

14. The separator of claim 1, wherein the coating layer has a thickness ranging from about 1 μm to about 3 μm.

15. A rechargeable lithium battery comprising:
the separator for a rechargeable lithium battery of claim 1;
a positive electrode; and
a negative electrode.
